(19) United States
(12) Patent Application Publication
(10) Pub. No.: US 2016/0051987 A1
(43) Pub. Date: Feb. 25, 2016

(54) CRUSHER INSPECTION HATCH

(71) Applicant: SANDVIK INTELLECTUAL PROPERTY AB, Sandviken (SE)

(72) Inventors: Bengt-Arne ERIKSSON, Svedala (SE); Patric MALMQVIST, Svedala (SE); Axel BERGMAN, Malmo (SE); Mikael M LARSSON, Eslov (SE)

(21) Appl. No.: 14/783,681

(22) PCT Filed: Mar. 17, 2014
(86) PCT No.: PCT/EP2014/055321

§ 371 Date: Oct. 9, 2015

(30) Foreign Application Priority Data
Apr. 11, 2013 (EP) 13163360.4

(51) Int. Cl. B02C 2/00; B02C 23/00

(52) U.S. Cl. CPC B02C 2/00; B02C 23/00

(57) ABSTRACT

A crusher inspection hatch assembly is provided at a crusher. The hatch assembly includes a frame surrounding the hatch opening and a door to close the opening when the hatch is not in use. A plurality of attachment elements secure the door to the frame. Each attachment element has a shaft and a nut with at least the nut component of the attachment element being prevented from separating from the hatch assembly via at least one abutment flange.

### FIELD OF INVENTION

The present invention relates to a crusher inspection hatch for a crusher and in particular, although not exclusively to a hatch assembly configured to prevent unintentional loss of at least parts of the attachment element used to secure a hatch door to a hatch opening provided at a region of the crusher.

### BACKGROUND ART

Gyratory crushers are used for crushing ore, mineral and rock material to smaller sizes. Typically, the crusher comprises a crushing head mounted upon an elongate main shaft. A first crushing shell (typically referred to as a mantle) is mounted on the crushing head and a second crushing shell (typically referred to as a concave) is mounted on a frame such that the first and second crushing shells define together a crushing gap through which material to be crushed is passed. A driving device positioned at a lower region of the main shaft is configured to rotate an eccentric assembly about the shaft to cause the crushing head to perform a gyratory pendulum movement and crush the material introduced in the crushing gap. Example gyratory crushers are described in WO 2004/110626; WO 2010/123431 and WO 2012/005651.

Similarly, vertical shaft impact crushers (VSI-crushers) are used in many applications for crushing hard material like rocks, ore etc., with examples described in WO 2004/020103 and WO 2010/042025.

Typically, an inspection hatch is provided through the bottom shell wall to allow maintenance access to the internal chamber to remove/dislodge crushable material and to inspect the various components of the internal chamber at regular intervals (typically once a month). Conventionally, a hatch door is secured to a hatch frame via two fastenings that each comprise screws that are fixed and project outwardly from the frame and are engageable with nuts that secure the door in the closed position about the hatch opening. Conventional designs of this type are problematic as the nuts are free to completely disengage the threaded shaft and are commonly lost when the door is removed for maintenance access. What is required is a crusher hatch assembly that addresses the above problems.

### SUMMARY OF THE INVENTION

It is an object of the present invention to provide a crusher inspection hatch assembly that is conveniently operated to open and close the hatch via movement of the door and adjustment of at least one attachment such that the attachment, or at least components of the attachment, are prevented from complete separation from the hatch frame or door and, in turn, unintentional loss during maintenance access.

The objectives are achieved via at least one abutment flange that forms a part of the hatch assembly and is configured to prevent or inhibit unintentional separation of at least component parts of the attachment used to secure the door to the hatch frame. In particular, the at least one attachment comprises an elongate shaft and a nut wherein the flange may be provided at a region of the shaft and/or the nut to engage regions of the hatch door, the hatch frame, the nut and/or the shaft so as to prevent or inhibit complete separation of at least two components of the assembly by abutment against at least one of the assembly components when the hatch door is released from a closed position at the hatch opening.

The attachment may comprise a threaded elongate shaft and a threaded nut engageable with the shaft or alternatively may comprise a bolt in which a bolt head is permanently, rigidly and/or integrally formed with a threaded shaft. The abutment flange may be releasably or substantially permanently attached to the shaft and/or head of the bolt. Optionally, the attachment comprises a plurality of abutment flanges attached to the bolt shaft and/or bolt head. As will be appreciated, the nut or bolt head may comprise a polygonal external profile to be engageable with a tool such as a spanner, wrench, socket and the like.

According to a first aspect of the present invention there is provided a crusher inspection hatch assembly provided at a crusher having a hatch opening in a wall of the crusher to allow access to an internal region defined by the wall, the hatch opening surrounded by a hatch frame, the assembly comprising: a door mountable at the frame to close the opening; at least one attachment to attach the door to the frame, the attachment comprising an elongate shaft and a nut; characterised by: at least one abutment flange provided at the shaft and/or nut to secure the nut or the nut and the shaft at a region of the frame or the door when the door is released from a position to close the opening.

Within the specification, reference to the attachment element comprising an elongate shaft and a nut encompasses an attachment element where the elongate shaft and nut are moveable relative to one another or are rigidly attached to define a bolt having a unitary structure formed from a bolt head and a shaft.

Preferably the door comprises at least one slot extending inwardly from a perimeter of the door. More preferably, the slot comprises at least one notch projecting inwardly to at least partially close a region of the slot. The notch therefore represents a further abutment flange where an abutment flange attached to the shaft is configured to prevent separation of the bolt from the door in an axial direction and the notch(s) at the slot is configured to prevent separation of the bolt from the door in a radial direction relative to an axis extending through the door and hatch and being aligned perpendicular to an axis extending through the crusher generally.

In one embodiment, the nut is rigidly attached to the shaft to define a bolt and comprises a flange extending radially outward from the shaft, the flange being separated axially from the nut. Preferably, the flange comprises an annular washer-like configuration that projects radially from the shaft.

Preferably, the door comprises a rim projecting radially outward from a boss, the at least one slot extending inwardly from a perimeter of the rim. Optionally, the rim comprises an oval or elliptical configuration and is centred at the boss. Optionally, the door comprises a cavity or recess and a handle region provided within the cavity or recess.

Where the shaft and nut are formed integrally to define a bolt, the flange may be axially separated from the nut (bolt head) by a distance substantially equal to a thickness of the rim at a region of the slot.

Optionally, the assembly comprises two notches positioned at opposed regions of the slot to define a neck portion of the slot to retain the nut and shaft at an inner region of the slot and inhibit the nut and shaft sliding outward from the slot. Optionally, the assembly comprises two substantially similar or identical attachment elements. According to further embodiments, the door may be configured with a pivot pin so as to be pivotally mounted at the hatch frame and is secured by one or a plurality of adjustable attachment elements as described herein.

Optionally, the frame comprises at least one borehole to receive the shaft for attachment of the door to the frame. Preferably, the borehole is threaded to cooperate with corresponding threads provided at the shaft.

Preferably, the notch comprises a resiliently deformable material. Preferably, the door comprises a resiliently deformable material.

Preferably, the crusher is a gyratory crusher and the frame is formed integrally with a bottom shell of the crusher. Alternatively, the frame may be formed non-integrally with the crusher frame or bottom shell and may comprise a single or multiple component assembly.

Preferably, the hatch assembly comprises two slots and two attachments (attachment elements) engageable with the slots to secure the door to the frame.

Preferably, the slots are aligned parallel to one another and provided at diametrically opposed regions at a perimeter of the door. The slots may extend substantially along one axial path such that the main lengths of the elongate slots are aligned along the same path. Alternatively, the slots may be provided at the door and extend from the door perimeter in different directions and in different orientations relative to a central axis extending through the door and boss. That is, the slots may extend radially relative to the axis or may extend tangentially relative to the axis.

According to a second aspect of the present invention there is provided a crusher comprising an inspection hatch assembly as claimed in any preceding claim. Preferably the inspection hatch assembly is provided at a gyratory crusher and in particular at a bottom shell of the gyratory crusher.

According to further embodiments the inspection hatch assembly may be provided at any manner of crusher including in particular a gyratory crusher, a cone crusher, a jaw crusher, an impact crusher, a shaft impactor/hammer mill, or a vertical shaft impactor. Additionally, the present hatch assembly may be positioned at any region of the crusher to gain access to an internal region within the crusher such as an internal chamber (for example a crushing or material discharge chamber) or compartment region where material is processed, where equipment is operative or stored and/or where working parts are located and concealed.

### BRIEF DESCRIPTION OF DRAWINGS

A specific implementation of the present invention will now be described, by way of example only, and with reference to the accompanying drawings in which:

FIG. 1 is a perspective view of a gyratory crusher having an input feed hopper mounted upon a topshell, mounted in turn upon a bottom shell where the bottom shell comprises an inspection hatch assembly according to a specific implementation of the present invention;

FIG. 2 is a magnified perspective view of the inspection hatch assembly of FIG. 1;

FIG. 3 is a partial exploded view of the inspection hatch assembly of FIG. 2;

FIG. 4 is a perspective view of the hatch door and attachment element of FIG. 3 according to a specific implementation of the present invention;

FIG. 5 is a perspective view of an inspection hatch having a hatch door and attachment elements according to a further specific implementation of the present invention.

### DETAILED DESCRIPTION OF PREFERRED EMBODIMENT OF THE INVENTION

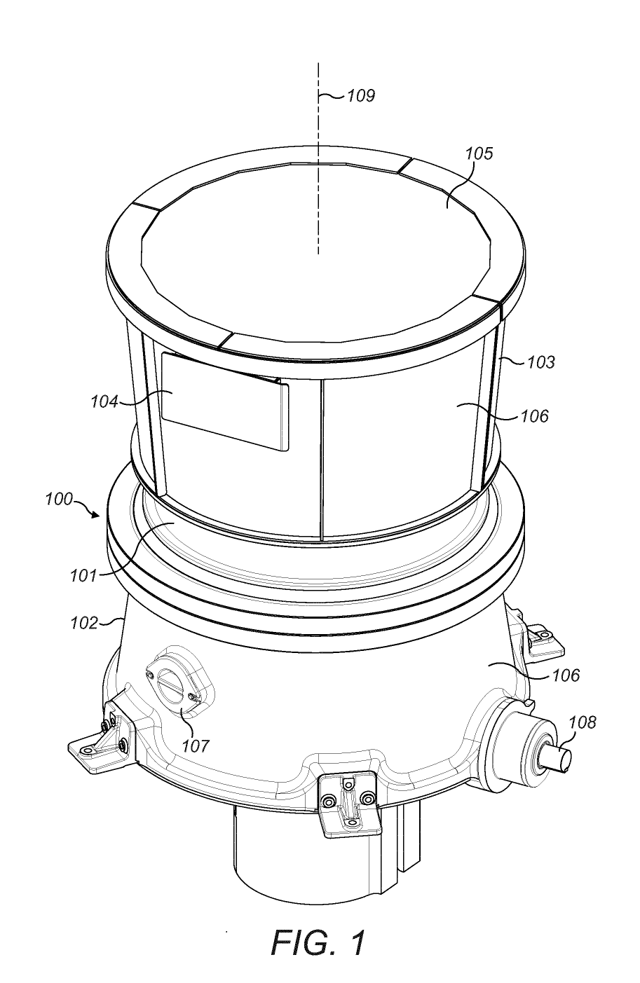

Referring to FIG. 1, a crusher comprises a frame 100 having an upper frame 101 (typically referred to as a top shell) and a lower frame 102 (typically referred to as a bottom shell) centred around a longitudinal axis 109. A crushing head (not shown) is mounted upon an elongate shaft (not shown). A first (inner) crushing shell (not shown) is fixably mounted on the crushing head and a second (outer) crushing shell (not shown) is fixably mounted at top shell 101. A crushing zone (not shown) is formed between the opposed crushing shells. A discharge zone (not shown) is positioned immediately below the crushing zone and is defined, in part, by the bottom shell 102.

A drive (not shown) is coupled to the main shaft via a drive shaft 108 and suitable gearing (not shown) no as to rotate the main shaft eccentrically about longitudinal axis 109 and to cause the head and the mantle to perform a gyratory pendulum movement and crush material introduced into the crushing chamber.

The material to be crushed is fed into the crushing chamber via an input hopper 103 that comprises an annular wall 106 centred around axis 109. A hopper hatch 104 is provided at wall 106 to allow maintenance and access into an internal chamber 105 defined by hopper wall 106. Hopper 103 is mounted directly upon top shell 101 and comprises a guide assembly (not shown) mounted within internal chamber 105 to ensure material to be crushed is efficiently fed into the internal crushing chamber within the crusher frame.

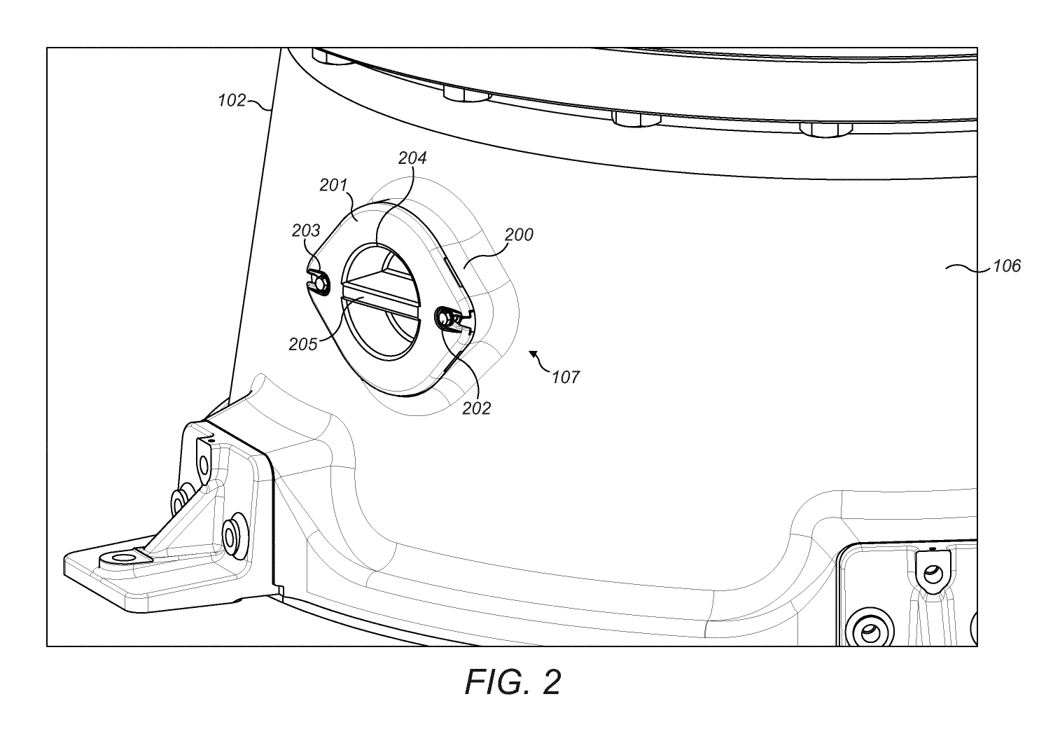

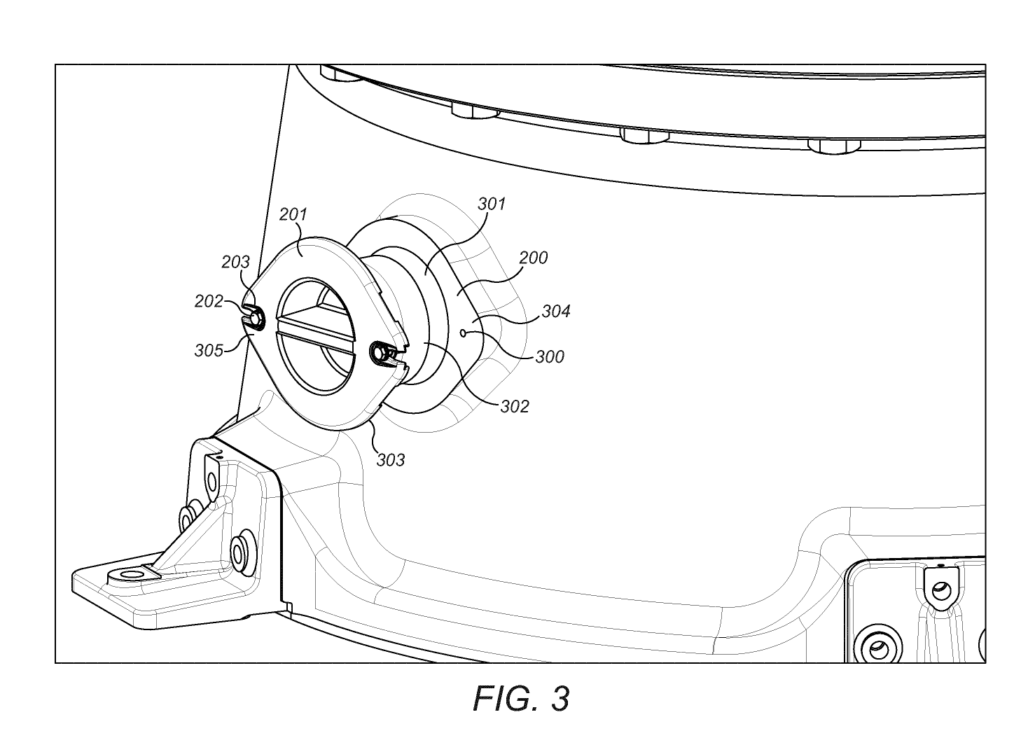

It is also necessary for periodic maintenance access into the internal chamber defined by bottom shell 102 and in particular by annular wall 106. Accordingly, bottom shell 102 comprises a plurality of inspection hatches 107 positioned at circumferentially spaced apart regions of bottom shell wall 106. Referring to FIGS. 2 and 3, each inspection hatch 107 comprises a frame 200 that is formed integrally with bottom shell wall 106 and defines a hatch opening 301. According to the specific implementation, opening 103 is circular and projects radially inward through frame 200 and bottom shell wall 106 relative to axis 109. A hatch door 201 is removeably mounted at frame 200. Door 201 comprises a boss portion 302 comprising a substantially cylindrical geometry and a rim portion 303 that is flared radially outward relative to boss 302 so as to define a plug-type geometry such that boss 302 is dimensioned to fit within opening 301 whilst rim 303 is configured for mating contact against the radially outermost surface of frame 200 (relative to axis 109). Frame 200 comprises two diametrically opposed flared regions 303 that increase the frame thickness relative to opening 301. A borehole 300 is provided at each flared regions 305 and comprises internal screw threads (not shown) to mate with corresponding screw threads of an attachment element. Frame 200 is formed as a flange that projects outward from wall 106 relative to axis 109. Door 201 comprises a central recess 204 in a form of a cylindrical cavity. A cross beam 205 extends centrally across cavity 204 and provides a handle by which maintenance personnel can grasp door 201 for removal and attachment at frame 200.

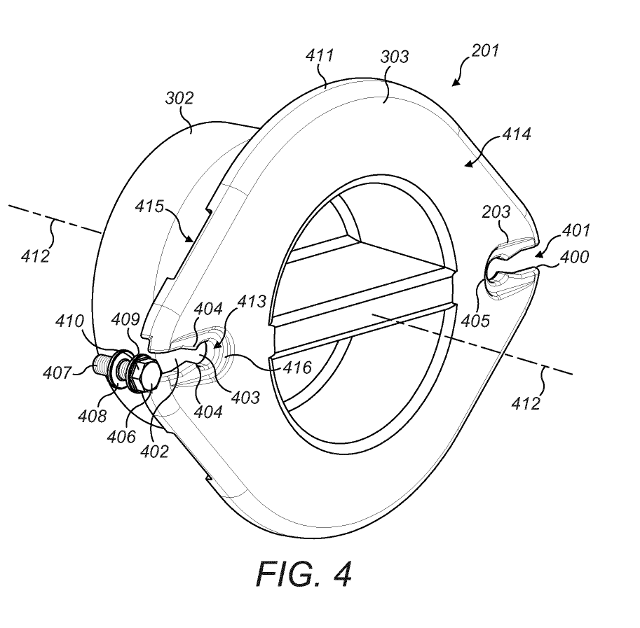

Referring to FIGS. 3 and 4, door 201 also comprises flared regions 305 that extend outward from boss 302 by a greater distance the majority of the rim portion 303. Each flared region 305 comprises a slot 203 that extends inwardly from a perimeter 411 of rim 303.

Each slot 203 is substantially elongate and extends from rim perimeter 411 to approximately align with the outer surface of boss 302 corresponding to approximately a full depth of rim 303 in a radially outward direction relative to an axis 412 extending through the plug-shaped door 201. Each slot 203 comprises a mouth region 401 representing an opening for slot 203 positioned approximately at perimeter 411 and defined by opposed slot sides 400. Slot 203 is terminated at its innermost end 405 by a curved section 413. A pair of wedges 404 project inwardly within slot 204 from the slot edges 400 to separate slot 203 into an inner head region 403 (positioned closest to end 405) and a tail region 402 (positioned closest to mouth 40)). Wedges 404 are formed integrally with door 201 which is in turn formed from a resiliently deformable material being typically rubber. The opposed wedges 404 create a constricted region within slot 203 such that the width of the slot between the opposed edges 400 decreases at the region between the wedges 404 where the slot width is aligned perpendicular to axis 412. This configuration provides a abutment flange to prevent separation of an attachment element 202 from door 201. As illustrated in FIGS. 1 to 4, the two slots 203 are positioned diametrically opposed at rim 303.

Door 201 is releasably attached to frame 200 and in turn bottom shell wall 106 via a pair of attachments 202. Each attachment 202 comprises a nut 406 rigidly attached to a threaded shaft 407 to define an attachment bolt. A first washer-like flange 408 extends around and projects radially outward from shaft 407 and is fixed in position at shaft 407 such that flange 408 is prevented from axial movement along shaft 407 in a direction of axis 412. A second flange 409 also extends around and projects radially outward from shaft 407 and is positioned in direct contact with nut (bolt head) 406. Each flange 408, 409 is configured for mating contact with a region of door 201 immediately surrounding each slot 203. In particular, second flange 409 is configured to sit against an outward facing surface 414 of rim 303 whilst first flange 408 is configured to sit against an inward facing surface 415 of rim 403 relative to axis 109. Accordingly, first flange 408 is axially separated from second flange 409 relative to axis 412 by a distance approximately equal to a thickness of rim 404 between faces 414 and 415 at the region of each slot 203. As illustrated in FIG. 4, each slot 203 is bordered by a recessed region 416 into outer face 414 such that each slot 203 is surrounded by a depression 416 indented into surface 414. Accordingly, second flange 409 is accommodated within recessed region 416 at the outer surface 414.

A diameter of shaft 407 is greater than the separation distance between wedges 404 whilst a separation distance between edges 400 at tail region 402 is greater than the diameter of shaft 407. Additionally, the diameter or separation of the edges 400 at head region 403 is greater than the diameter of shaft 407. Accordingly, the attachment element 202 and door 201 may be mated together such that the pair of attachment elements 202 are releasably coupled and held within each slot 203 by virtue of the opposed wedges 404. Wedges 404 are configured to resiliently deform to allow the passage of shaft 407 from tail region 402 into head region 403 and then to return in shape to effectively trap each attachment element 202 within each slot 203 at head region 203. Referring to axis 412, each attachment element 202 is prevented from radial movement along slot 203 (and hence radial separation from door 20)) via the opposed wedges 404 and prevented from axial displacement from rim 303 via the first and second flanges 408, 409. Accordingly, when door 201 is removed from frame 200, attachment elements 202 are retained at door 201 to prevent their unintentional loss or misplacement.

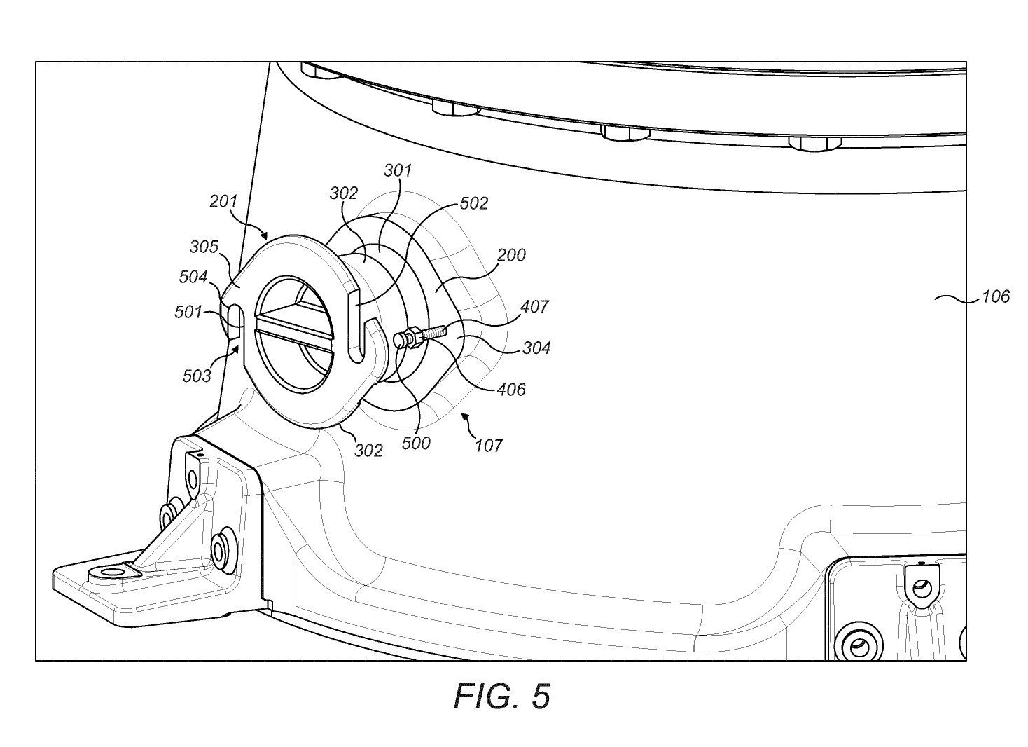

FIG. 5 illustrates a further embodiment of the subject invention. In this embodiment, the attachment elements are permanently attached and extend radially from bottom shell 106 (relative to axis 109) and are engageable to release and retain door 201 at the maintenance hatch 107. In particular, two threaded shafts 407 extend at diametrically opposed parts of frame 200 corresponding to flared regions 304. A nut 406 is rotatably mounted about shaft 407. A flange 500 is positioned at an end region of shaft 407 furthest from frame 200. Flange 500 extends radially outward from shaft 407 to provide a back-stop to prevent nut 406 from being separated from shaft 407 at this end. Accordingly, nut 406 is capable of shuttling back and forth between frame 200 and stop flange 500 via cooperating screw threads.

According to the further embodiment, door 201 comprises corresponding slots 501, 502 provided at the flared regions 305. However, unlike the embodiment of FIGS. 1 to 4 where a length of each slot from mouth 401 to the innermost end 405 extends on the same axial path perpendicular to axis 412, slots 401 and 502 are orientated in different directions. That is, a first slot 501 when mated against frame 200 in normal use is orientated to be upwardly projecting such that mouth 503 is positioned below innermost end 504. A second slot 502 comprises the opposite arrangement but with mouth 503 positioned above innermost end 504. This configuration enables door 201 to be mated against frame 200 via a twist-lock action. That is, door 201 is rotated about axis 412 to orientate each mouth 503 to engage about the respective shaft 407. Door 201 is then rotated in an opposite direction about axis 412 to embed each shaft 407 within each slot 501, 502 at the innermost end 504. Nut 406 is then advanced along shaft 407 to clamp door 201 against frame 200. Door 201 may be released from frame 200 by the reverse process. However, as indicated, nuts 406 are retained at shafts 407 by flange 500 when door 201 is released.

According to yet further embodiments, the assembly may comprise one adjustable attachment element as described with reference to FIGS. 1 to 5 and a second attachment element about which door 201 may pivot at frame 200. Accordingly, only one attachment element comprises a moveable nut or bolt component (as described) with the second attachment element comprising a conventional pivot pin or similar. As will be appreciated, further embodiments comprising one or two attachment elements may comprise any form of shaft, nut and bolt arrangement in which a flange or plurality of flanges are configured to mate with a region of door 201, nut (bolt head) 406, shaft 407 and/or frame 200 so as to prevent undesirable separation of two components of the attachment element such as the nut 406 from shaft 407 (in the case of the embodiment of FIG. 5) or the separation of the bolt 406, 407 from door 201 (in the case of embodiment of FIG. 4).

1. A crusher inspection hatch assembly provided at a crusher having a hatch opening in a wall of the crusher to allow access to an internal region defined by the wall, the hatch opening being surrounded by a hatch frame, the assembly comprising:
a door mountable at the frame to close the opening;
at least one attachment to attach the door to the frame, the attachment including an elongate shaft and a nut;
at least one abutment flange provided at the shaft and/or nut to secure the nut or the nut and the shaft at a region of the frame or the door when the door is released from a position to close the opening.

2. The assembly as claimed in claim 1, wherein the door includes at least one slot extending inwardly from a perimeter of the door.

3. The assembly as claimed in claim 2, wherein the slot includes at least one notch projecting inwardly to at least partially close a region of the slot.

4. The assembly as claimed in claim 2 wherein the nut is rigidly attached to the shaft to define a bolt and comprises a flange extending radially outward from the shaft, the flange being separated axially from the nut.

5. The assembly as claimed in claim 4, wherein the door includes a rim projecting radially outward from a boss, the at least one slot extending inwardly from a perimeter of the rim.

6. The assembly as claimed in claim 5, wherein the flange is axially separated from the nut by a distance substantially equal to a thickness of the rim at a region of the slot.

7. The assembly as claimed in claim 3, further comprising two notches positioned at opposed regions of the slot to define a neck portion of the slot to retain the nut and shaft at an inner region of the slot and to inhibit the nut and shaft from sliding outward from the slot.

8. The assembly as claimed in claim 1, wherein the frame includes at least one borehole to receive the shaft for attachment of the door to the frame.

9. The assembly as claimed in claim 3, wherein the notch includes a resiliently deformable material.

10. The assembly as claimed in claim 1, wherein the door is formed from a resiliently deformable material.

11. The assembly as claimed in claim 1, wherein the shaft includes screw threads.

12. The assembly as claimed in claim 1, wherein the frame is formed integrally with a bottom shell of the crusher.

13. The assembly as claimed in claim 2, further comprising two slots and two attachments engageable with the slots to secure the door to the frame.

14. A crusher comprising:
a hatch opening in a wall of the crusher to allow access to an internal region defined by the wall, the hatch opening being surrounded by a hatch frame; and
an inspection hatch assembly including a door mountable at the frame to close the opening, at least one attachment to attach the door to the frame, the attachment including an elongate shaft and a nut, and at least one abutment flange provided at the shaft and/or nut to secure the nut or the nut and the shaft at a region of the frame or the door when the door is released from a position to close the opening.

15. The crusher as claimed in claim 14, wherein the crusher is a gyratory crusher having a bottom shell, the inspection hatch assembly being provided at the bottom shell.

16. The assembly as claimed in claim 1, wherein the frame is formed non-integrally with a bottom shell of the crusher.
